(19) United States
(12) Patent Application Publication
(10) Pub. No.: US 2020/0065863 A1
(43) Pub. Date: Feb. 27, 2020

(54) UNIFIED PROPENSITY MODELING ACROSS PRODUCT VERSIONS

(71) Applicant: Microsoft Technology Licensing, LLC, Redmond, WA (US)

(72) Inventors: Xia Hong, Sunnyvale, CA (US); Xiang Li, Santa Clara, CA (US); Mazen M. Yanbeiy, San Francisco, CA (US); Kuo-Ning Huang, Los Altos, CA (US); Wei Di, Cupertino, CA (US); Yongzheng Zhang, San Jose, CA (US)

(73) Assignee: Microsoft Technology Licensing, LLC, Redmond, WA (US)

(21) Appl. No.: 16/114,036

(22) Filed: Aug. 27, 2018

(51) Int. Cl. G06Q 30/02; G06F 17/30; G06K 9/62; G06N 99/00; G06N 5/04

(52) U.S. Cl. CPC G06Q 30/0269; G06Q 30/0254; G06N 5/04; G06K 9/6256; G06N 99/005; G06F 17/30705

(57) ABSTRACT

The disclosed embodiments provide a system for performing unified propensity modeling across product versions. During operation, the system determines features and labels related to converting to multiple versions of a product by a first set of members, wherein the features and the labels span a unified timeframe and adhere to a unified data logic. Next, the system inputs the features and the labels as training data for one or more machine learning models. The system then applies the machine learning model(s) to additional features for a second set of members to produce scores representing likelihoods of the second set of members converting to the multiple versions of the product. Finally, the system generates, based on the scores, output for targeting the second set of members with the product.

### BACKGROUND

### Field

The disclosed embodiments relate to propensity modeling. More specifically, the disclosed embodiments relate to techniques for performing unified propensity modeling across product versions.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, run advertising and marketing campaigns, promote products and/or services, and/or search and apply for jobs.

In turn, online networks may facilitate activities related to business, sales, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for performing unified propensity modeling in accordance with the disclosed embodiments.

FIG. 3 shows a flowchart illustrating a process of performing unified propensity modeling in accordance with the disclosed embodiments.

FIG. 4 shows a flowchart illustrating a process of determining features and labels for use in unified propensity modeling in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing unified propensity modeling across product versions. The product versions may include multiple versions of a product and/or multiple products. For example, a premium account subscription with an online network may include different versions that are geared toward career development, recruiting, sales, marketing, small businesses, and/or other types of activities. In another example, the online network may include different products related to recruiting, marketing, sales, advertising, and/or educational technology.

More specifically, the disclosed embodiments may unify the modeling of user propensities for converting to different products and/or product versions. Such modeling may be performed using one or more machine learning models, which can include a different model for each product version and/or a multiclass classification model that outputs multiple user propensities for converting to the corresponding products or product versions.

First, the unified propensity modeling may include data-level unification that ensures that features and/or labels inputted into the model(s) span a unified timeframe and adhere to a unified data logic. As a result, the data-level unification may standardize the generation of labels and/or features across different product versions and/or channels used to target the users with the product versions.

Second, model-level unification may ensure that scores outputted by each machine learning model are comparable across the products and/or product versions. For example, model-level unification may be used to calibrate the scores so that a given score value represents the same propensity to convert, independent of the model used to generate the score and/or the product version to which the score pertains.

Third, score-level unification may be used to select a technique for targeting the users with recommendations related to the product and/or product versions. For example, one or more thresholds may be applied to the scores to identify a subset of users to target with the recommendations, generate a recommendation of a specific product version for some users, and/or generate a “unified” recommendation of the product without specifying a product version for other users.

By unifying the generation and use of training data, machine learning models, and/or scores associated with predicting user propensities in converting to multiple products and/or versions, the disclosed embodiments may allow the propensities to be compared and analyzed in a standardized and/or meaningful way. In turn, such unification may reduce overlap or conflict in targeting users with multiple products and/or product versions and improve the usefulness of product recommendations to the users. In contrast, conventional predictive analytics commonly involves generating features, training machine learning models, and/or predicting user propensities on a per-product basis, which precludes meaningful comparison of the predicted propensities across the products and/or effective user targeting based on the predicted propensities. Consequently, the disclosed embodiments may improve technologies related to the performance and/or use of propensity models, recommendation systems, and/or online platforms; the performance and/or functionality of network-enabled devices and/or applications used to execute or access the propensity models, recommendation systems, and/or online platforms; and/or user engagement, user experiences, and interaction through the online platforms and/or products offered by or through the online platforms.

### Unified Propensity Modeling Across Product Versions

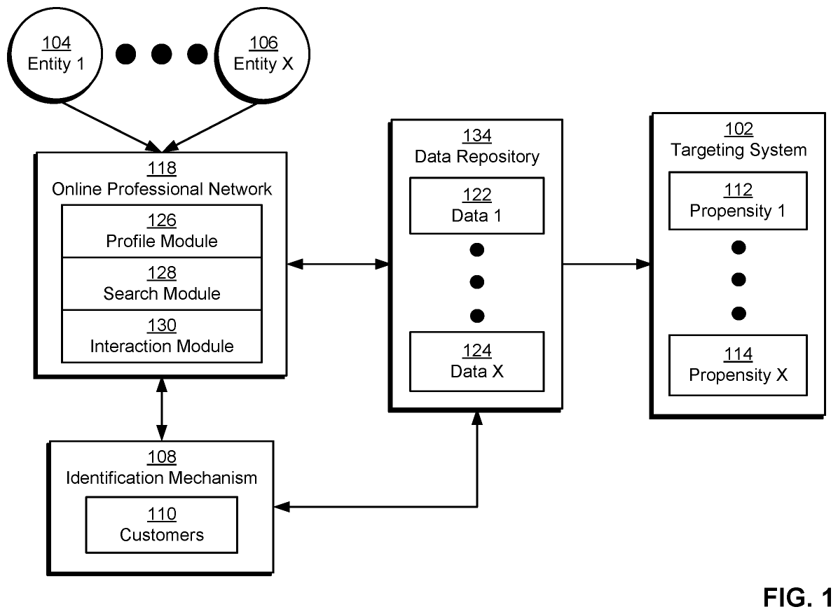

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

The entities may also include a set of customers 110 that purchase products through online professional network 118. For example, the customers may include individuals and/or organizations with profiles on online network 118, recruiters that conduct hiring or recruiting activities within or through online network 118, and/or sales accounts with sales professionals that operate through online network 118. As a result, customers 110 may use online network 118 to interact with professional connections, list and apply for jobs, reach out to potential candidates for jobs, establish professional brands, purchase or use products offered through the online professional network, advertise, learn or improve skills, and/or conduct other activities in a professional and/or business context.

Customers 110 may also be targeted with products that are offered by or through online network 118. For example, the customers may be users and/or companies that purchase business products and/or solutions that are offered by online network 118 to achieve goals related to hiring, marketing, advertising, selling, and/or learning. In another example, the customers may be individuals and/or companies that are targeted by marketing, recruiting, and/or sales professionals through online network 118.

As shown in FIG. 1, customers 110 may be identified by an identification mechanism 108 using data from data repository 134 and/or online network 118. For example, identification mechanism 108 may identify customers 110 by matching profile data, group memberships, industries, skills, customer relationship data, and/or other data for customers 110 to keywords related to products that may be of interest to customers 110. Identification mechanism 108 may also identify customers 110 as individuals and/or companies that have sales accounts with online network 118 and/or products offered by or through online network 118. As a result, customers 110 may include entities that have purchased products through and/or within online network 118, as well as entities that have not yet purchased but may be interested in products offered through and/or within online network 118.

Identification mechanism 108 may also match customers 110 to products using different sets of criteria. For example, identification mechanism 108 may match customers 110 in recruiting roles to recruiting solutions, customers 110 in sales roles to sales solutions, customers 110 in marketing roles to marketing solutions, and customers 110 in advertising roles to advertising solutions. If different versions of a solution are available, identification mechanism 108 may also identify the variation that may be most relevant to a customer based on the size, location, industry, and/or other attributes of the customer. In another example, products offered by other entities through online network 118 may be matched to current and/or prospective customers 110 through criteria specified by the other entities. In a third example, customers 110 may include all entities in online network 118, which may be targeted with products such as “premium” subscriptions or memberships with online network 118.

After customers 110 are identified, a targeting system 102 may target customers 110 with relevant products based on propensities (e.g., propensity 1 112, propensity x 114) of customers 110 in converting to the products. As discussed in further detail below, targeting system 102 may unify the modeling of user propensities for converting to different products and/or product versions. Such unified modeling may be performed using one or more machine learning models, such as a different classification model for each product version and/or a multiclass classification model that outputs user propensities for converting to multiple product versions. In addition, such unified modeling may involve unification of data, modeling, and scoring across the products and/or product versions, thus allowing targeting system 102 to meaningfully compare the propensities across the products and/or product versions and prioritize targeting of customers 110 with products and/or product versions to which customers 110 are most likely to convert.

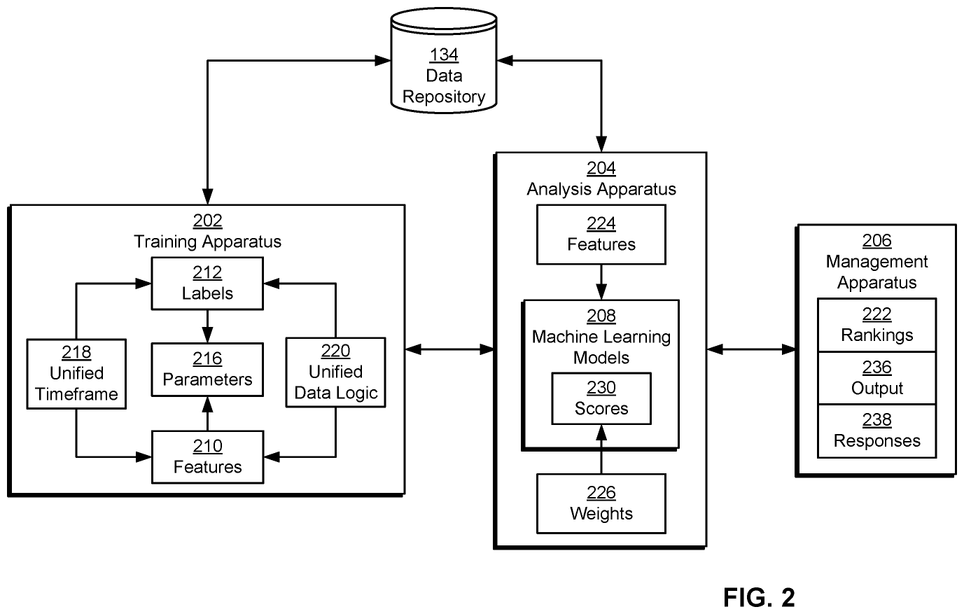

FIG. 2 shows a system for performing unified propensity modeling (e.g., targeting system 102 of FIG. 1) in accordance with the disclosed embodiments. As shown in FIG. 2, the system includes a training apparatus 202, an analysis apparatus 204, and a management apparatus 206. Each of these components is described in further detail below.

As mentioned above, the system of FIG. 2 may be used to generate scores 230 representing predicted propensities of customers to convert to different products and/or product versions. For example, each propensity may represent the predicted likelihood of a user that is a customer purchasing a subscription to a career development, recruiting, sales, and/or small business version of a premium account with an online network (e.g., online network 118 of FIG. 1) or other type of user community. The propensities may also, or instead, include predicted likelihoods of customers purchasing different types of products offered by or through the online network (e.g., recruiting solutions, sales solutions, marketing solutions, educational technology products, advertising solutions, etc.).

In addition, scores 230 may be produced and/or calibrated to lie along the same scale, so that a given score value represents a certain propensity of converting, independent of the machine learning model (e.g., machine learning models 208) used to generate the score and/or the product or product version to which the score pertains. As a result, scores 230 may be compared across machine learning models 208, products, and/or product versions to allow strategic targeting of customers based on the customers' propensities of converting to the corresponding products and/or product versions.

To enable direct comparison of scores 230, training apparatus 202 unifies the training of one or more machine learning models 208 used to produce scores 230. In particular, training apparatus 202 may generate features 210 and labels 212 that are inputted as training data for machine learning models 208 so that features 210 and labels 212 span unified timeframe 218 and adhere to unified data logic 220.

Features 210 may include attributes and/or behavior of the users/customers that are indicative of their propensities in converting to the products and/or product versions. Features 210 may include profile data associated with member profiles of the users (e.g., in the online network and/or another community). For example, profile data for an online network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. The profile data may also include a set of groups to which the user belongs, the user's contacts and/or connections, awards or honors earned by the user, licenses or certifications attained by the user, patents or publications associated with the user, and/or other data related to the user's interaction with the community.

Attributes of the users may be matched to a number of member segments, with each member segment containing a group of users that share one or more common attributes. For example, member segments in the community may be defined to include members with the same industry, title, location, and/or language.

Connection information in the profile data may additionally be combined into a graph, with nodes in the graph representing entities (e.g., users, schools, companies, locations, etc.) in the community. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

Features 210 may also, or instead, include user activity data generated from records of user interactions with one another and/or content associated with the community. For example, the user activity data may be used to track impressions, clicks, likes, dislikes, shares, hides, comments, posts, updates, conversions, and/or other user interaction with content and/or modules in the community. The user activity data may also, or instead, track other types of community activity, including connections, messages, job applications, job searches, recruiter searches for candidates, interaction between job candidates and recruiters, and/or interaction with groups or events. The user activity data may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data may additionally include schedules, calendars, and/or upcoming availabilities of the users, which may be used to schedule meetings, interviews, and/or events for the users.

Labels 212 may represent outcomes of targeting the users via one or more marketing and/or advertising channels. The channels may include an email channel, in which emails recommending products or product versions are transmitted to the users. Because the users may take time to view and/or respond to recommendations in the emails, each email may include a timeframe for response within which a corresponding outcome is determined. For example, a user that receives a marketing email may have seven days to respond to an email that recommends one or more products to the user. If the user converts to a recommended product within the seven-day period, training apparatus 202 may assign a positive label to the user. If the user does not convert to a recommended product within the seven-day period, training apparatus 202 may assign a negative label to the user.

The channels may also, or instead, include an in-product channel, in which notifications, messages, and/or user-interface elements recommending the products or product versions are shown to the users as the users interact with the online network and/or another type of online platform. As a result, a positive label (e.g., a label of 1) may be generated for a user when the user converts to a product on a day when the user is active on the online platform and/or views an in-product recommendation, and a negative label (e.g., a label of 0) may be generated for the user when the user does not convert to the product on a day when the user is active on the online platform and/or views an in-product recommendation.

In one or more embodiments, training apparatus 202 generates labels 212 in a way that adheres to unified data logic 220 for all products and/or product versions. First, a given outcome may be associated with one or more labels 212 that indicate how the corresponding user was targeted. For example, users may be targeted with recommendations for specific product versions of a product (e.g., a business, career, recruiting, and/or sales version of a premium account subscription with the online platform) over the email channel. On the other hand, the users may be targeted with recommendations that lack specific product versions (e.g., recommendations to try out the premium account subscription without specifying a version) over the in-platform channel.

As a result, the user may be associated with one or more labels 212 that indicate how the user was targeted and whether or not the user responded to the targeting. Continuing with the above example, a user that is targeted with a recommendation for a specific product version (e.g., over the email channel) may be assigned two labels 212, one for the product version and one for the general product. If the user converts to the recommended product version within the corresponding timeframe for response (e.g., a week after receiving the email), both labels may be positive. If the user converts to a different product version from the recommended product version within the timeframe, the label for the product version may be negative (since the user did not sign up for the recommended product version), while the label for the general product may be positive (since the user converted to some version of the product after receiving the email). If the user does not convert to any version of the product within the corresponding timeframe, both labels may be negative.

Conversely, a user that is targeted with a recommendation for the general product (e.g., over the in-platform channel) instead of a specific product version may have only one label for the general product. The label may be positive if the user signs up for any version of the product within the corresponding timeframe for response (e.g., on the same day that the user is shown the recommendation within the online platform) and negative if the user does not sign up for any version of the product within the timeframe.

Training apparatus 202 may also merge or “flatten” labels 212 within one or more time windows associated with unified timeframe 218. For example, training apparatus 202 may aggregate multiple negative labels 212 representing negative outcomes from multiple emails sent to a user and/or multiple user sessions with the online platform over a four-week time window into a single negative label for the time window and/or a different negative label for each product and/or product version with which the user was targeted within the time window. In a second example, training apparatus 202 may remove all negative labels 212 for a user if the user has at least one positive label in the time window. In a third example, training apparatus 202 may aggregate multiple positive labels 212 for a specific product version and the general product into a single positive label for the product version. In other words, training apparatus 202 may retain, for each user assigned one or more labels 212 in a given time window, a single negative label (if the user does not convert at all) or a single positive label (for each product and/or product version to which the user converts).

Similarly, features 210 may be generated based on unified timeframe 218 and dates associated with the merged and/or flattened labels 212. For example, unified timeframe 218 may include one or more predefined “lookback windows” of days or weeks over which features 210 for a given user are collected. Each lookback window may end on the last day in a given time window in which a label is generated for a user (e.g., the last day in which an email is sent to the user and/or the user is active on the platform), so that features generated within the lookback window reflect the user's behavior or preferences leading up to the label. If the user has labels for both the email and in-platform channels, the latest date of the user's label for a higher-priority channel (e.g., the email channel) may be used as the end date for the lookback window. Alternatively, separate sets of features may be generated for two separate lookback windows, one of which ends at the latest date associated with the user's label for the email channel and the other of which ends at the latest date associated with the user's label for the in-platform channel.

Features 210 may also, or instead, be generated based on periods of user activity with or within the online platform. For example, features 210 for a user may include a “snapshot” of the user's latest activity with the online platform and/or of a day on which a label is generated for the user.

After labels 212 and features 210 for a set of users are generated under unified timeframe 218 and according to unified data logic 220, training apparatus 202 may input labels 212 and features 210 as training data for machine learning models 208. For example, machine learning models 208 may include a separate classification model (e.g., logistic regression, tree-based model, neural network, support vector machine, etc.) for each product and/or product version for which unified propensity modeling is performed. Machine learning models 208 may also, or instead, include a multicicass classification model that outputs a user's propensities for converting to multiple product versions and/or products based on a corresponding set of features 210. As a result, training apparatus 202 may use a training technique and/or one or more hyperparameters to update parameters 216 (e.g., coefficients, weights, etc.) of each machine learning model based on the features 210 and labels 212 associated with the corresponding product(s) and/or product version(s). In turn, the machine learning model may be trained to predict labels 212 based on the corresponding features 210. After parameters 216 are created and/or updated, training apparatus 202 may store parameters 216 in data repository 134 and/or another data store for subsequent retrieval and use.

After parameters 216 of machine learning models 208 are created and/or updated, analysis apparatus 204 applies machine learning models 208 to additional features 224 for the same users and/or different users to produce scores 230 that reflect the likelihoods of the users converting to the corresponding products or product versions. For example, analysis apparatus 204 may retrieve parameters 216 of machine learning models 208 from data repository 134 and generate one or more sets of features 224 to conform to unified timeframe 218 and unified data logic 220. Analysis apparatus 204 may input each set of features 224 into the corresponding machine learning model, and each machine learning model may output a score ranging from 0 to 1 representing the likelihood that a given user converts to a given version of the product.

Analysis apparatus 204 may also adjust scores 230 using a set of weights 226. For example, weights 226 may include calibration weights for standardizing scores 230 from one or more machine learning models 208 that predict user propensities for converting to different products and/or product versions. The calibration weights may optionally be produced as scores and/or other output from additional machine learning models and/or using a statistical technique that adjusts scores 230 from machine learning models 208 to have the same distribution. After the calibration weights are applied, the standardized scores 230 may be comparable across the products and/or product versions and/or used to generate a “profile” of each user's predicted preferences with respect to the products and/or product versions.

In another example, weights 226 may include customer lifetime values (CLVs), potential spending, and/or other metrics representing future spending with each product or product version by the users. In turn, scores 230 may be scaled by weights 226 to emphasize user-product pairs with high likelihood of converting and/or high potential spending.

Finally, management apparatus 206 may perform targeting of the users with the products based on scores 230. First, management apparatus 206 produces rankings 222 of the members by scores 230. For example, management apparatus 206 may rank the members by descending score for each product and/or product version.

Next, management apparatus 206 generates output 236 for targeting the members with the products and/or product versions based on the corresponding rankings 222. For example, management apparatus 206 may identify a pre-specified number and/or proportion of users with the highest scores 230 in each ranking and/or a variable number of users with scores 230 that exceed a threshold from each ranking. Management apparatus 206 may then generate emails, notifications, messages, advertisements, and/or other output 236 that targets the identified users with the corresponding products and/or product versions. Output 236 may recommend a specific product version to a user, or output 236 may recommend the general product instead of a specific product version to allow the user to decide which product version best suits the user's needs.

Management apparatus 206 may additionally vary output 236 based on scores 230 and/or the users' positions in rankings 222. For example, management apparatus 206 may generate output 236 that targets a user with a specific product version when the user's score for the product version exceeds a “high confidence” threshold and/or is significantly higher than the user's scores for all other product versions. Management apparatus 206 may also, or instead, generate output 236 that targets a user with the general product instead of a specific product version when the user's scores for all product versions are lower than the threshold and/or relatively similar to one another.

Management apparatus 206 and/or another component may further track responses 238 of the users to output 236 and convert responses 238 into additional labels 212. For example, the component may generate a positive label for a user when the user converts within the timeframe for response to output 236 and negative when the user fails to convert within the timeframe. In turn, training apparatus 202 may use the additional labels 212 and the corresponding features 210 to update parameters 216 of machine learning models 208 on a periodic and/or continuous basis, thereby improving the performance of machine learning models 208 and/or allowing machine learning models 208 to adapt to changes in user behavior over time.

By unifying the generation and use of training data, machine learning models, and/or scores associated with predicting user propensities in converting to multiple products and/or versions, the system of FIG. 2 may allow the propensities to be compared and analyzed in a standardized way. In turn, such unification may reduce overlap or conflict in targeting users with multiple products and/or product versions and improve the usefulness of product recommendations to the users. In contrast, conventional predictive analytics commonly involves generating features, training machine learning models, and/or predicting user propensities on a per-product basis, which precludes meaningful comparison of the predicted propensities across the products and/or effective user targeting based on the predicted propensities. Consequently, the system may improve technologies related to the performance and/or use of propensity models, recommendation systems, and/or online platforms; the performance and/or functionality of network-enabled devices and/or applications used to execute or access the propensity models, recommendation systems, and/or online platforms; and/or user engagement, user experiences, and interaction through the online platforms and/or products offered by or through the online platforms.

Those skilled in the art will appreciate that the system of FIG. 2 may be implemented in a variety of ways. First, training apparatus 202, analysis apparatus 204, management apparatus 206, and/or data repository 134 may be provided by a single physical machine, multiple computer systems, one or more virtual machines, a grid, a cluster, one or more databases, one or more filesystems, and/or a cloud computing system. Training apparatus 202, analysis apparatus 204, and management apparatus 206 may additionally be implemented together and/or separately by one or more hardware and/or software components and/or layers.

Second, a number of machine learning models 208 and/or techniques may be used to generate scores 230. For example, the functionality of each machine learning model may be provided by a regression model, artificial neural network, support vector machine, decision tree, random forest, gradient boosting tree, naïve Bayes classifier, Bayesian network, clustering technique, deep learning model, hierarchical model, and/or ensemble model.

Moreover, the same machine learning model or separate machine learning models may be used to generate scores 230 for various users, user segments, products, product versions, and/or other groupings of users and/or products. For example, a different “individual” machine learning model may be used to estimate likelihoods of converting to a given product version. In another example, a joint model and/or multiclass classification model may output multiple scores 230 for each user, with each score representing the user's estimate propensity in converting to a different product version. In a third example, the output of the join and/or multiclass classification model may be combined with the output of the individual machine learning models to produce scaled and/or calibrated scores 230 that are used to generate rankings 222 and/or output 236. In a fourth example, different versions of a machine learning model may be created to predict propensities of different segments of users in converting to one or more products or product versions.

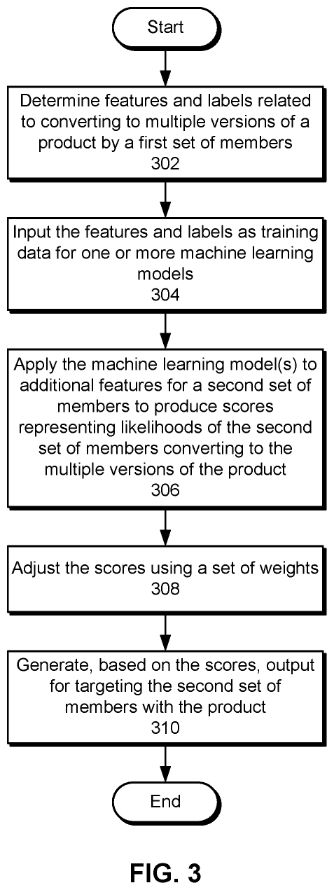

FIG. 3 shows a flowchart illustrating a process of performing unified propensity modeling in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

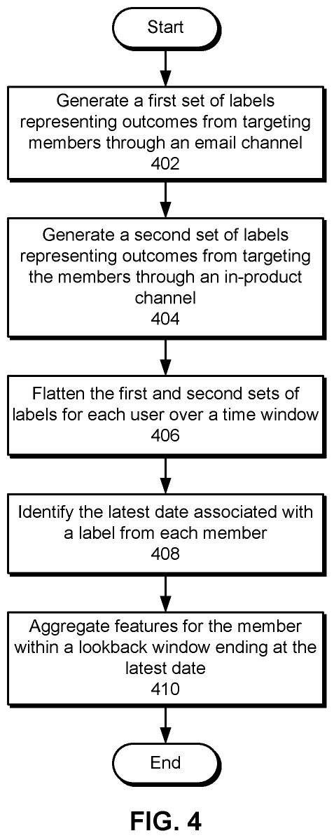

Initially, features and labels related to converting to multiple versions of a product by a first set of members (e.g., users who are members of an online platform) are determined (operation 302), as described in further detail below with respect to FIG. 4. Next, the features and labels are inputted as training data for one or more machine learning models (operation 304). For example, the features and labels may be used to update the parameters of separate classification models that predict user propensities in converting to individual product versions and/or a multiclass classification model that outputs user propensities for converting to multiple product versions.

The machine learning model(s) are then applied to additional features for a second set of members to produce scores representing likelihoods of the members converting to multiple versions of the product (operation 306). For example, each machine learning model may output one or more scores ranging from 0 to 1, with each score representing the probability that a member converts to a given version of the product.

The scores are also adjusted using a set of weights (operation 308). For example, the weights may include calibration weights for standardizing the scores across the product versions and/or customer lifetime values for the users.

Finally, output for targeting the second set of members with the product is generated based on the scores (operation 310). For example, the users may be ranked by descending score for each product version, and a pre-specified number or proportion of highest-ranked members and/or a variable number of members with scores that exceed a threshold in each ranking may be selected for targeting. In turn, each selected member may be shown an email, notification, in-platform message, in-product upsell, and/or other type of output that recommends the general product and/or a specific product version to the member. The output may identify a specific product version when the corresponding values of the member's scores indicate a high confidence in the member converting to the product version (e.g., a much higher score for the product version than for other product versions and/or a score for the product version that exceeds a threshold). Conversely, the output may omit a specific product version when the corresponding values of the member's scores do not indicate high confidence in the member converting to any product version.

FIG. 4 shows a flowchart illustrating a process of determining features and labels for use in unified propensity modeling in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a first set of labels representing outcomes from targeting members through an email channel is generated (operation 402). For example, the first set of labels may be generated based on the members' responses to emails that recommend one or more products and/or product versions to the members. Each label may be determined from the corresponding member's response (or lack of response) within a time window (e.g., a week) after the member receives an email.

Next, a second set of labels representing outcomes from targeting the members through an in-product channel is generated (operation 404). Unlike the first set of labels, the second set of labels may be determined based on active dates of the members with the in-product channel over a unified timeframe (e.g., a pre-specified number of days or weeks). For example, a label may be generated for a member for each day in which the member is active on (e.g., has a user session with) an online platform through which the products and/or product versions are offered or used.

The first and second sets of labels are then flattened for each user over a time window (operation 406). For example, each user may have multiple labels representing outcomes from multiple emails sent to the user and/or multiple sessions the user had with the online platform over a time window of days or weeks. When the user has one or more positive labels within the time window, all negative labels for the user may be removed or dropped. When the user has only negative labels within the time window, the negative labels may be merged into a single negative label for a given product and/or product version.

Finally, the latest date associated with a label from each member is identified (operation 408), and features for the member are aggregated within a lookback window ending at the latest date (operation 410). For example, the latest date may be the last day in the time window in which the member receives an email via the email channel and/or the last day in the time window in which the member is active on the online platform associated with the in-product channel In turn, the lookback window may include a certain number of days or weeks prior to the latest date, so that features aggregated within the lookback window reflect the user's behavior or preferences leading up to the last day in which the user was targeted. After the labels and features are generated, the labels and features may be used to train one or more machine learning models, as discussed above.

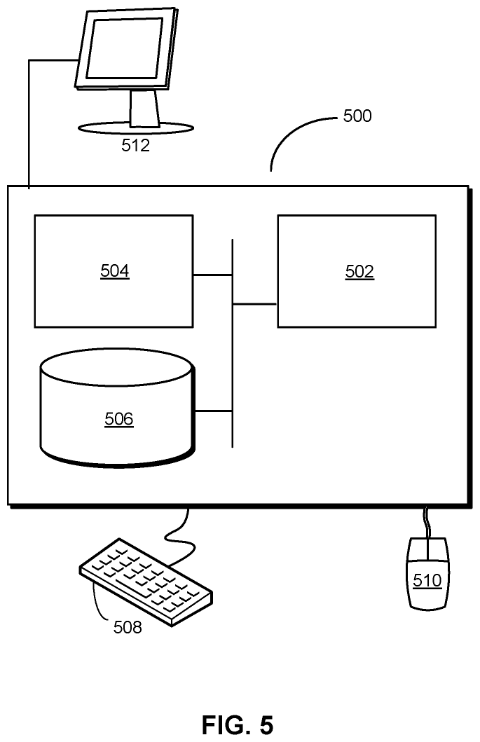

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for performing unified propensity modeling across multiple product versions. The system includes a training apparatus, an analysis apparatus, and a management apparatus, one or more of which may alternatively be termed or implemented as a module, mechanism, or other type of system component. The training apparatus determines features and labels related to converting to multiple versions of a product by a first set of members. Next, the training apparatus inputs the features and the labels as training data for one or more machine learning models. The analysis apparatus then applies the machine learning model(s) to additional features for a second set of members to produce scores representing likelihoods of the second set of members converting to the multiple versions of the product. Finally, the management apparatus generates, based on the scores, output for targeting the second set of members with the product.

In addition, one or more components of computer system 500 may be remotely located and connected to the other components over a network. Portions of the present embodiments (e.g., training apparatus, analysis apparatus, management apparatus, data repository, machine learning models, online network, etc.) may also be located on different nodes of a distributed system that implements the embodiments. For example, the present embodiments may be implemented using a cloud computing system that generates output for targeting a set of remote users with recommended products and/or product versions.

By configuring privacy controls or settings as they desire, members of a social network, online professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining, by one or more computer systems, features and labels related to converting to multiple versions of a product by a first set of members, wherein the features and the labels span a unified timeframe and adhere to a unified data logic;
inputting, by the one or more computer systems, the features and the labels as training data for one or more machine learning models;
applying, by the one or more computer systems, the one or more machine learning models to additional features for a second set of members to produce scores representing likelihoods of the second set of members converting to the multiple versions of the product; and
generating, based on the scores, output for targeting the second set of members with the product.

2. The method of claim 1, further comprising:
adjusting the scores using a set of weights prior to generating the output based on the scores.

3. The method of claim 2, wherein the set of weights comprises at least one of:
customer lifetime values for the members; and
calibration weights for standardizing the scores across the multiple product versions.

4. The method of claim 1, wherein determining the features and the labels for the multiple product versions comprises:
identifying a latest date associated with a label from a member; and
aggregating the features for the member within a lookback window ending at the latest date.

5. The method of claim 1, wherein determining the features and the labels for the multiple versions of the product comprises:
generating a first subset of the labels representing outcomes from targeting the first set of members through an email channel; and
generating a second subset of the labels representing additional outcomes from targeting the first set of members through an in-product channel.

6. The method of claim 5, wherein generating the first subset of the labels comprises:
determining an outcome associated with a member within a time window after the member is targeted through the email channel.

7. The method of claim 5, wherein generating the second subset of the labels comprises:
determining an outcome associated with a member based on active dates of the member with the in-product channel over the unified timeframe.

8. The method of claim 1, wherein the one or more machine learning models comprise a separate machine learning model for each version in the multiple versions of the product.

9. The method of claim 1, wherein the one or more machine learning models comprise a multiclass classification model.

10. The method of claim 1, wherein generating the output for targeting the second set of members with the product comprises:
applying one or more thresholds to the scores to identify a subset of members in the second set of members with high likelihood of converting to the multiple versions of the product; and
targeting each member in the subset of members based on corresponding values of the scores for the member.

11. The method of claim 10, wherein targeting each member in the subset of members based on the corresponding values of the scores for the member comprises at least one of:
targeting the member with a message that identifies a product version when the corresponding values of the scores indicate a high confidence in the member converting to the product version; and
targeting the member with a message that lacks any product versions when the corresponding values of the scores do not indicate the high confidence in the member converting to a specific product version.

12. The method of claim 1, wherein the multiple product versions comprise at least one of:
a business version;
a job-seeking version;
a recruiting version;
a sales version; and
an educational technology product.

13. A system, comprising:
one or more processors; and
memory storing instructions that, when executed by the one or more processors, cause the system to:
determine features and labels related to converting to multiple versions of a product by a first set of members, wherein the features and the labels span a unified timeframe and adhere to a unified data logic;
input the features and the labels as training data for one or more machine learning models;
apply the one or more machine learning models to additional features for a second set of members to produce scores representing likelihoods of the second set of members converting to the multiple versions of the product; and
generate, based on the scores, output for targeting the second set of members with the product.

14. The system of claim 13, wherein the memory further stores instructions that, when executed by the one or more processors, cause the system to:
adjust the scores using a set of weights prior to generating the output based on the scores.

15. The system of claim 14, wherein the set of weights comprises at least one of:
customer lifetime values for the members; and
calibration weights for standardizing the scores across the multiple product versions.

16. The system of claim 13, wherein determining the features and the labels for the multiple product versions comprises:
identifying a latest date associated with a label from a member; and
aggregating the features for the member within a lookback window ending at the latest date.

17. The system of claim 13, wherein determining the features and the labels for the multiple versions of the product comprises:
generating a first subset of the labels representing outcomes from targeting the first set of members through an email channel; and
generating a second subset of the labels representing additional outcomes from targeting the first set of members through an in-product channel.

18. The system of claim 13, wherein generating the output for targeting the second set of members with the product comprises:
applying one or more thresholds to the scores to identify a subset of members in the second set of members with high likelihood of converting to the multiple versions of the product; and
targeting each member in the subset of members based on corresponding values of the scores for the member.

19. The system of claim 18, wherein targeting each member in the subset of members based on the corresponding values of the scores for the member comprises at least one of:
targeting the member with a message that identifies a product version when the corresponding values of the scores indicate a high confidence in the member converting to the product version; and
targeting the member with a message that lacks any product versions when the corresponding values of the scores do not indicate the high confidence in the member converting to a specific product version.

20. A non-transitory computer-readable storage medium storing instructions that when executed by a computer cause the computer to perform a method, the method comprising:
determining features and labels related to converting to multiple versions of a product by a first set of members, wherein the features and the labels span a unified timeframe and adhere to a unified data logic;
inputting the features and the labels as training data for one or more machine learning models;
applying the one or more machine learning models to additional features for a second set of members to produce scores representing likelihoods of the second set of members converting to the multiple versions of the product; and
generating, based on the scores, output for targeting the second set of members with the product.
